(19) United States
(12) Patent Application Publication
(10) Pub. No.: US 2023/0142746 A1
(43) Pub. Date: May 11, 2023

(54) SELF-HEALING MATERIAL

(71) Applicant: Petroliam Nasional Berhad (PETRONAS), Kuala Lumpur (MY)

(72) Inventors: Marcello SOLOMON, South Australia (AU); Jane ZHANG, Victoria (AU); Christian DOONAN, South Australia (AU); Russell VARLEY, Victoria (AU); M Shamsul Farid SHAMSUDIN, Kuala Lumpur (MY); NorFarah Diana ABA, Kuala Lumpur (MY); Muzdalifah Bt ZAKARIA, Kuala Lumpur (MY); Kok Hoong LEONG, Kuala Lumpur (MY)

(21) Appl. No.: 17/915,926

(22) PCT Filed: Mar. 31, 2021
(86) PCT No.: PCT/MY2021/050022

§ 371 Date: Sep. 29, 2022

(30) Foreign Application Priority Data
Apr. 1, 2020 (MY) PI 2020001678

(51) Int. Cl. C08L 61/24; C08L 63/00; C08G 59/40

(52) U.S. Cl. CPC C08L 61/24; C08L 63/00; C08G 59/4021; C08L 2207/53

(57) ABSTRACT

Disclosed herein is a self-healing material comprising microcapsules comprising a monomeric or oligomeric healing agent, and a catalyst that is able to catalyse the polymerisation of the monomeric or oligomeric healing agent.

### FIELD OF THE INVENTION

The present invention relates generally to self-healing materials, and to methods of enabling said material to heal itself.

### BACKGROUND

Self-healing materials are substances that have the ability to automatically repair damage to themselves without any external diagnosis of the problem or human intervention. Generally, materials will degrade over time due to fatigue, exposure to the environment, or damage incurred during operation of a device using said materials. It has been shown that cracks and other types of damage lead to a change in the thermal, electrical and acoustic properties of a material, which can lead to the eventual failure of the material (e.g. through the propagation of cracks in the material). Damage (e.g. cracks) can be hard to detect at an early stage and periodic inspection and repair is normally required for conventional materials. In contrast, self-healing materials counter degradation through the initiation of a repair mechanism which responds to the micro-damage.

Given the above, self-healing materials are of great commercial interest because they can provide an extended service life and the possibility of reduced maintenance costs compared to an equivalent conventional material. Self-healing materials are expected to have many useful applications in the built environment and are expected to become increasingly important in a carbon-constrained world because they enable resource efficiency to be increased.

Human reliance on fossil fuels and petrochemical feedstocks necessitate a well-connected and robust infrastructure. Failure anywhere in said infrastructure could result in significant environmental consequences, such as oil spills or gas leaks. However, pipes that transport oil and CO₂ at elevated pressures are subject to strongly corrosive environments, which can result in damage to the material(s) used in the pipes. Additionally, oil and gas pipes are often located underground (exposing them to corrosion from soil) or under the sea (exposing them to corrosion from salt water), and accessing these locations to inspect and repair the pipes can be challenging. The incorporation of a self-healing mechanism into such pipes to extend their life would be of great benefit to industry.

Current pipeline technologies use a three layered system, which are vulnerable to failure in certain environments. The metal surface of the pipe is coated with an epoxy primer, which facilitates the adhesion of a polypropylene layer and an inert polypropylene topcoat. The epoxy primer and the polypropylene adhesive layers contain accessible functional groups that can be exploited for self-healing.

One class of self-healing material is based on the encapsulation of a healing agent (for example, in microcapsules) within a polymer matrix. Capsule-based self-healing polymer composites were first described by White et al., Nature 2001, 409, pp. 794-797. As a crack forms and propagates through the polymer matrix it will rupture the microcapsules, releasing the healing agent into the crack plane. A catalyst is dispersed throughout the polymer matrix, and eventually the healing agent comes into contact with the dispersed catalyst. This triggers curing/polymerization, healing the crack faces and restoring mechanical integrity.

Most previously described self-healing materials are based on ring-opening metathesis polymerisation (ROMP) using precious metal catalysts, such as Grubb's catalyst (which is based on ruthenium) and platinum nanoparticles. As well as being very expensive, Grubb's catalyst does not exhibit long term stability under the ambient conditions where capsule-based self-healing materials would be helpful (e.g. in a pipeline used for oil and gas). As such, precious metal catalysts are impractical for use in self-healing materials operating under harsh ambient conditions, such as the commercial transportation of oil and gas.

Another approach involves using dual-microcapsules in which a healing agent and polymerizer/hardener are separately encapsulated. However, the process of encapsulating hardeners is quite complex and this approach is not commercially viable due to its high complexity and high cost. Furthermore, this approach requires similar numbers of capsules of both the healing agent and polymerizer/hardener to rupture and homogeneously mix. The inclusion of two separate capsule types could also impact the properties of the material, since the amount of each capsule type needed to ensure self-healing can approach 30 wt % for each capsule type. Finally, the liquid reagents used in this approach may not have the necessary stability for use in self-healing materials designed to have a long product life — especially where these materials will be exposed to a harsh environment.

Given the above, there remains a need for new and improved self-healing materials. Particularly for self-healing materials in the oil and gas industry.

### SUMMARY OF THE INVENTION

The inventors have surprisingly found that the above challenges can be overcome by providing the catalyst in the form of a metal-organic framework (MOF). MOFs are suitable for incorporating into various layers of oil pipes and other polymer-based materials due to their stability and customisable functionality for anchoring within the polymeric matrix. For example, the inner layers of an oil pipe often contain hydroxy, epoxy, maleimide and anhydride functional groups, which can be used as anchoring points for a functionalised MOF backbone. Since the inner layers are exposed to particularly harsh conditions, the use of self-healing materials in the construction of these layers is expected to be particularly helpful to ensure a satisfactory product lifetime.

The invention therefore provides the following.

1. A self-healing material comprising:
a polymeric matrix;
microcapsules comprising a shell portion and a hollow core portion, where the microcapsules are dispersed within the polymeric matrix and the hollow core portion is filled with a monomeric or oligomeric healing agent; and
a metal-organic framework catalyst that is suitable for catalysing the polymerisation of the monomeric or oligomeric healing agent.

2. The self-healing material according to Clause 1, wherein the metal-organic framework catalyst is dispersed within the polymeric matrix.

3. The self-healing material according to Clause 1 or 2, wherein the shell portion of the microcapsules is formed from one or more of the group consisting of a urea-formaldehyde, polysulfone, and polymethyl methacrylate.

4. The self-healing material according to Clause 3, wherein the shell portion of the microcapsules is formed from a urea-formaldehyde, optionally wherein the urea-formaldehyde is melamine-modified urea-formaldehyde.

5. The self-healing material according to any one of the preceding clauses, wherein the average diameter of the microcapsules is from about 20 μm to about 200 μm, optionally from about 50 μm to about 100 μm.

6. The self-healing material according to any one of the preceding clauses, wherein the shell portion of the microcapsules has an average thickness of from about 100 nm to about 500 nm, optionally from about 200 nm to about 400 nm, more optionally from about 250 nm to about 350 nm, such as about 300 nm.

7. The self-healing material according to any one of the preceding clauses, wherein the self-healing material comprises from about 10 to about 30 wt % of the microcapsules, optionally from about 12 to about 25 wt %, more optionally from about 15 to about 25 wt %, such as about 20 wt % of the microcapsules.

8. The self-healing material according to any one of the preceding clauses, wherein the self-healing material comprises from about 1 to about 10 wt % of metal-organic framework catalyst, optionally from about 3 to about 8 wt %, more optionally from about 4 to about 6 wt %, such as about 5 wt %.

9. The self-healing material according to Clause 1, wherein the shell portion of the microcapsules comprises an inner portion and an outer portion, where the outer portion comprises the metal-organic framework catalyst.

10. The self-healing material according to Clause 9, wherein the inner portion is formed from polymerised monomeric or oligomeric healing agent.

11. The self-healing material according to Clause 9 or 10, wherein the outer portion is formed from polymerised monomeric or oligomeric healing agent, or wherein the outer portion is formed from one or more of the group consisting of a urea-formaldehyde, polysulfone, and polymethyl methacrylate.

12. The self-healing material according to Clause 11, wherein the outer portion is formed from polymerised monomeric or oligomeric healing agent.

13. The self-healing material according to Clause 11, wherein the outer portion is formed from a urea-formaldehyde, optionally wherein the urea-formaldehyde is melamine-modified urea-formaldehyde.

14. The self-healing material according to any one of Clauses 9 to 13, wherein the average diameter of the microcapsules is from about 20 to about 200 μm, optionally from about 50 to about 100 μm.

15. The self-healing material according to any one of Clauses 9 to 14, wherein the shell portion of the microcapsules has an average thickness of from about 100 nm to about 500 nm, optionally from about 200 nm to about 400 nm, more optionally from about 250 nm to about 350 nm, such as about 300 nm.

16. The self-healing material according to any one of Clauses 9 to 15, wherein the self- healing material comprises from about 10 to about 40 wt % of the metal-organic framework- containing microcapsules, optionally from about 15 to about 35 wt %, more optionally from about 20 to about 30 wt %, such as about 25 wt % of the microcapsules.

17. The self-healing material according to any one of Clauses 9 to 16, wherein the self- healing material comprises from about 1 to about 10 wt % of metal-organic framework catalyst, optionally from about 3 to about 8 wt %, more optionally from about 4 to about 6 wt %, such as about 5 wt %.

18. The self-healing material according to any one of the preceding clauses, wherein the monomeric or oligomeric healing agent comprises an epoxy resin, optionally a bisphenol-based epoxy resin.

19. The self-healing material according to any one of the preceding clauses, wherein the epoxy resin comprises an epoxy resin selected from the group consisting of bisphenol epoxy resins; glycidyl ether resins; glycidyl aniline resins; and novolac, aliphatic, cycloaliphatic, aromatic, and bio-based epoxy resins that have from 1 to 6, such as from 1 to 4, epoxy groups,
optionally wherein the epoxy resin is selected from the group consisting of bisphenol F diglycidyl ether (DGEBF), bisphenol A diglycidyl ether (DGEBA), and Araldite® LY564.

20. The self-healing material according to any one of the preceding clauses, wherein the metal-organic framework comprises a zeolitic imidazolate framework.

21. The self-healing material according to any one of the preceding clauses, wherein the metal-organic framework comprises ligands selected from the group consisting of imidazole, 2-methylimidazole, 2-nitroimidazole, 4,5-dichloroimidazole, 2-imidazolecarboxaldehyde and combinations thereof.

22. The self-healing material according to any one of the preceding clauses, wherein the metal-organic framework comprises a zeolitic imidazolate framework selected from the group consisting of ZIF-2, ZIF-3, ZIF-4, ZIF-8, ZIF-67, ZIF-65, ZIF-77, ZIF-71, ZIF-72, ZIF-90 and combinations thereof.

23. The self-healing material according to any one of the preceding clauses, wherein the metal-organic framework comprises ZIF-8.

24. A method of healing a self-healing material as defined in any one of the preceding clauses, comprising a step of subjecting the self-healing material to conditions suitable for polymerisation of the monomeric or oligomeric healing agent.

25. The method according to Clause 24, wherein the conditions suitable for polymerisation of the monomeric or oligomeric healing agent self-healing material comprise a temperature of from about 20° C. to about 180° C.

26. The method according to Clause 24 or 25, wherein the self-healing material is subjected to conditions suitable for polymerisation of the monomeric or oligomeric healing agent for at least one hour, optionally at least two hours, more optionally at least six hours, even more optionally at least 10 hours, further optionally at least 16 hours, such as at least 24 hours.

27. The method according to any one of Clauses 24 to 26, wherein the self-healing material forms part of an oil or gas pipeline that is maintained at conditions suitable for polymerisation of the monomeric or oligomeric healing agent.

### BRIEF DESCRIPTION OF THE FIGURES

FIG. 1 shows the general structure of a zeolitic imidazolate framework.

FIG. 2 shows the polymerisation reaction between imidazole and epoxy resin.

FIG. 3 shows the propagation of a crack 301 through a self-healing material 302. As the crack propagates it ruptures microcapsules 303 comprising a monomeric or oligomeric healing agent that is released into the crack (step ii)). The healing agent will come into contact with a metal-organic framework catalyst 304 embedded in a polymeric matrix, which catalyses the polymerisation of the healing agent to produce a solid polymer 305a, 305b, in the crack and microcapsules, thereby healing the crack.

FIG. 4 shows the XRD spectra of ZIF-8 synthesised according to Preparative Example 1.

FIG. 5 shows an SEM image of the ZIF-8 particles synthesised according to Preparative

Example 1.

FIG. 6a shows an SEM image of microcapsules synthesised according to Preparative Example 2.

FIG. 6b shows a high magnification SEM image of a single microcapsule synthesised according to Preparative Example 2.

FIG. 7 shows an optical microscope image of broken microcapsules showing released epoxy as described in Preparative Example 2. The capsule 701 is broken to release epoxy 702.

FIG. 8 shows a microscope image of cured RIM 935/936 epoxy matrix incorporated with MUF/epoxy capsules as described in Preparative Example 2.

FIG. 9a shows an SEM image of the cross section of a RIM 935/936—MUF/epoxy composite showing broken capsules as described in Preparative Example 2.

FIG. 9b shows a high magnification SEM image of the shell portion of a microcapsule synthesised according to Preparative Example 2.

FIG. 10 shows a graph depicting in-situ healing temperature profile as described in Example 1.

FIG. 11 shows the in-situ healing process of a) bare RIM 935; b) 8% ZIF8 in RIM 935; and c) 25% capsule-8% ZIF8 in RIM 935, as described in Example 1.

FIG. 12 shows microscope images of a) Bare RIM 935; b) 8% ZIF8 in RIM 935; and c) 25% capsule-8% ZIF8 in RIM 935 samples before (left) and after (right) healing, as described in Example 2. 1201 shows the released epoxy and 1202 shows cured epoxy.

FIG. 13 shows the log of |Z| at a frequency of 0.1Hz for the bare RIM 935 pristine sample; and control and self-healing samples with different concentration of MUF capsules and ZIF8 after scratching and 12 h healing at 60° C., as described in Example 3.

FIG. 14 shows optical microscopy images of samples after 20 h Electrochemical Impedance Spectroscopy (EIS) test described in Example 3.

FIG. 15 shows the healing efficiency of the samples with 25% MUF capsules and 8% ZIF8 as a function of temperature, as described in Example 4.

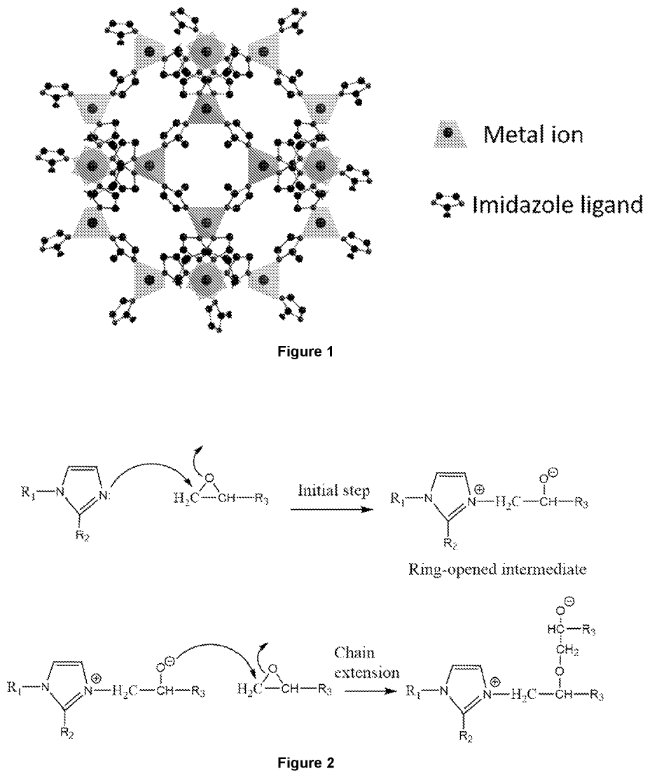

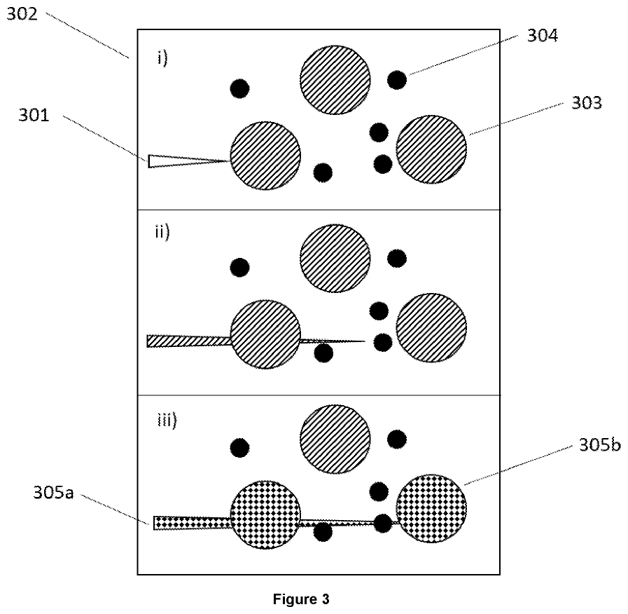

### DETAILED DESCRIPTION OF THE INVENTION

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

The present invention provides a self-healing material. As used herein, a “self-healing material” is a material that is able to at least partially heal defects that form in or on the material. For example, a self-healing material may be able to at least partially heal cracks and/or scratches that form in or on the material. In particular embodiments that may be described herein, the self-healing material is able to at least partially heal cracks that form in the material. It may be necessary to heat the material as described herein in order for the self-healing process to occur. The ability of a material to self-heal may be determined by any suitable method known in the art, for example by Electrical Impedance Spectroscopy (EIS) or by a Single Edge Notched Bend test such as ASTM5045. A measurement after self-healing can be compared against a control, and the degree of healing determined. In embodiments described herein, when subjected to appropriate conditions the self-healing material has a healing efficiency as determined by these methods of at least 50%, such as at least 60%, at least 70%, at least 80% or at least 90% and reference to at least partial healing should she construed accordingly.

The self-healing material comprises microcapsules. As used herein, a microcapsule is a microparticle comprising a solid shell which encapsulates a core.

The solid shell portion of the microcapsules may be formed from any suitable material, such as a urea-formaldehyde resin, polysulfone, polymethyl methacrylate and combinations thereof. In embodiments of the invention that may be mentioned herein, the solid shell portion of the microcapsules comprises a urea-formaldehyde resin. In embodiments of the invention that may be mentioned herein, when the solid shell portion of the microcapsules comprises a urea-formaldehyde resin, it may comprise a melamine-modified urea-formaldehyde resin (MUF), which itself is formed from a mixture of melamine, urea and formaldehyde. Melamine-modified urea-formaldehyde resins have good thermal stability and barrier properties due to the triazine ring of the melamine, which also increases the stability in moisture environments.

The core portion of the microcapsules is filled with a monomeric or oligomeric healing agent, which is provided as a liquid. As used herein, “filled with” means that the hollow volume of the core portion is at least partially filled with the monomeric or oligomeric healing agent. For example, at least 60%, at least 70%, at least 80%, at least 90%, at least 95%, at least 99%, such as about 100% of the volume of the core portion of the microcapsule may be filled with monomeric or oligomeric healing agent. Typically, at least 90%, such as at least 95%, at least 99%, for example about 100% of the volume of the core portion of the microcapsule may be filled with monomeric or oligomeric healing agent.

The monomeric or oligomeric healing agent is provided in a state such that it is released from the microcapsule when the shell is ruptured. Thus, when the microcapsules are ruptured by a scratch or crack, the monomeric or oligomeric healing agent is able to flow into or otherwise occupy the void formed by the scratch or crack. As the healing agent flows into the void, it will contact the metal-organic framework catalyst. The monomeric or oligomeric healing agent is compatible with the metal-organic framework catalyst such that the catalyst catalyses a polymerisation reaction of the monomeric or oligomeric healing agent. As such, contact between the monomeric or oligomeric healing agent and the metal-organic framework catalyst results in a polymerisation reaction, forming a solid polymer within the aforementioned void. This fills the void, thereby healing the self-healing material.

Any monomeric or oligomeric healing agent may be used, so long as it is able to flow into the void formed by a scratch or crack so as to fill the void. For this reason, liquid monomeric or oligomeric healing agent are particularly preferred. A particular class of monomeric or oligomeric healing agents that may be used in embodiments described herein is epoxy resins, which are advantageously cheap and easy to polymerise using readily available catalysts such as amines and imidazoles. As used herein, an epoxy resin refers to a composition comprising monomers and/or prepolymers that contain epoxide functional groups. Particular epoxy resins that may be used in the present invention include bisphenol epoxy resins; glycidyl ether resins; glycidyl aniline resins; and novolac, aliphatic, cycloaliphatic, aromatic, and bio-based epoxy resins that have from 1 to 6, such as from 1 to 4, epoxy groups. Particular epoxy resins that may be used in embodiments of the invention mentioned herein are bisphenol F diglycidyl ether (DGEBF), bisphenol A diglycidyl ether (DGEBA), and Araldite® LY564.

Any metal-organic framework catalyst that is compatible with the monomeric or oligomeric healing agent may be used. Metal-organic framework catalysts are advantageous over precious metal catalysts in view of their ease of production, lower cost and stability over the lifetime of a self-healing material. A particular class of metal-organic frameworks that may be used is a zeolitic imidazolate framework (ZIF), which are robust, easy to synthesise on a large scale and significantly cheaper than precious metal catalysts. ZIFs are able to catalyse the polymerisation of epoxy functional groups due to the presence of the nucleophilic nitrogen atom on the imidazole ring.

The general structure of a ZIF is shown in FIG. 1. The structure comprises tetrahedrally coordinated transition metal ions surrounded by ligands that are imidazolate or imidazolate derivatives (i.e. an imidazole or imidazole derivative which is deprotonated at the nitrogen atom). The imidazolate ligands are believed to coordinate to the transition metal ions through the nitrogen atoms. The structure of imidazole and imidazolate are shown below.

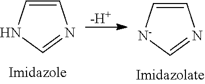

As will be appreciated by a person skilled in the art, the ZIFs of use in the present invention may comprise imidazolate ligands, or may comprise imidazolate derivative ligands, which derivatives may be substituted at one or more positions on the imidazole ring as shown below.

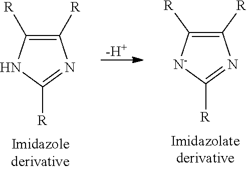

In embodiments of the invention, the transition metal ion in the ZIF is selected from the group consisting of Fe, Co, Cu and Zn, where the transition metal ion has a charge of 2+.

In general, the ratio of imidazolate/imidazolate derivative ligands to metal ions will be such that the overall charge of the ZIF is neutral. As an example, when the transition metal ions have a charge of 2+, the ratio of imidazolate ligands to metal ions will be 2:1.

A large number of ZIFs exist, with the common structure being a backbone comprising imidazolate ligands as shown in FIG. 1. The imidazolate ligand may be derived from imidazole (ZIF-2 to ZIF-4), 2-methylimidazole (ZIF-8 or ZIF-67), 2-nitroimidazole (ZIF-65 and ZIF-77), 4,5-dichloroimidazole (ZIF-71 and ZIF-72) or 2-imidazolecarboxaldehyde (ZIF-90). The functionality on the imidazole ligand can be tuned to provide the desired properties. A key factor in the reactivity of the imidazolate ligand and its ability to act as a catalyst for the epoxy curing reaction is the steric hindrance of the tertiary amine. By controlling the side groups on the imidazolate ligand, the reactivity of the tertiary amine, and accordingly the ZIF catalyst, can be tuned.

Furthermore, the particle size of the resultant ZIF particle can be controlled by varying the synthesis conditions, such as the stirring speed of the mixture of ZIF precursors, ratio of ZIF precursors (i.e. imidazole to metal ion ratio), types of ZIF precursors, and the solvent. A higher stirring speed will result in a smaller ZIF particle size, and a greater imidazole to metal ion ratio will also result in a smaller particle size. The solvent used will affect the ZIF formation speed and resulting particle size. Without being bound by theory, it is believed that the hydrogen bonding donation ability of the solvent affects the crystallisation rate and resulting particle size. The suspension of the catalytic imidazole moiety in the solid-state means that the challenges associated with liquid reagents are avoided.

Another advantage associated with the use of MOFs is that MOFs can form Pickering Emulsions (a liquid/liquid emulsion that is stabilised by the presence of solid particles at the liquid/liquid interface). Advantageously, the microcapsules can be prepared from a Pickering Emulsion to generate microcapsules having the MOF catalyst in the microcapsule shell portion, and the monomeric or oligomeric healing agent in the microcapsule core. This can be achieved via the addition of healing agent to the oil phase of an oil/water emulsion. If solid MOF catalyst is added, it will gather at the oil/water interface. This results in polymerisation of the healing agent at the oil-water interface, forming a solid shell comprising polymerised healing agent and the MOF, surrounding a liquid healing agent core. The shell physically separates the MOF from the liquid healing agent, forming a multifunctional capsule comprising the healing agent with a catalytic shell. Upon rupturing of the capsule, the healing agent will be released and there will be guaranteed contact with the ZIF catalyst. This results in an advantageous increase in self-healing consistency and reliability when compared to self-healing materials having separate particles of catalyst and healing agent.

When the microcapsule is formed from a Pickering Emulsion as described above, the shell is formed from the polymerisation of the liquid monomeric or oligomeric healing agent. As the polymerisation reaction progresses, a thin layer of polymer will be formed separating the immobile MOF from the liquid healing agent core. This prevents further polymerisation of the liquid healing agent core. The shell of the microcapsule will therefore comprise an inner layer or portion of a brittle polymer (which could include other components from the oil phase, such as polystyrene or divinyl benzene) that separates the MOF from the liquid core, and an outer brittle shell layer or portion that comprises the MOF. Given that the MOF may not be evenly distributed around each oil droplet in the Pickering Emulsion, there may not be a distinct boundary between the inner and outer shell layers/portions. The MOF may sit on the outer layer (i.e. the outer layer is a thin layer partially penetrated by MOF, or the MOF may be dispersed within the outer layer (i.e. the outer layer is thicker and fully covers the MOF).

Thus, in embodiments of the invention disclosed herein, the shell portion of the microcapsule may comprise the metal-organic framework catalyst. As will be appreciated by a person skilled in the art, when a microcapsule shell comprising the MOF catalyst is prepared from a Pickering emulsion, the formed shell will prevent contact between the monomeric or oligomeric healing agent and the MOF catalyst. Thus, in embodiments of the invention the shell portion of the microcapsules may comprise an inner portion that contacts the monomeric or oligomeric healing agent, and an outer portion that comprises the MOF catalyst. The inner portion of the shell (which contacts the monomeric or oligomeric healing agent) is formed from polymerised monomeric or oligomeric healing agent, and does not comprise any MOF catalyst (i.e. there is a portion of polymerised healing agent between the monomeric or oligomeric healing agent and the MOF catalyst). The inner portion is a thin part of the microcapsule shell that separates the MOF catalyst from the liquid monomeric or oligomeric healing agent in the core of the microcapsule. The outer portion may also be formed from polymerised monomeric or oligomeric healing agent, and is the portion of the shell that comprises the MOF catalyst. In this case, the MOF catalyst may be present on the outer surface of the outer shell portion, or may be present within the outer shell portion. Further, where the inner and outer portions are formed from polymerised healing agent, there is not necessarily a clear boundary between the inner and outer shell portions.

The outer shell portion may be formed from a different material, such as one or more of the group consisting of a urea-formaldehyde, polysulfone, and polymethyl methacrylate. In this case, the microcapsule shell will comprise an inner shell portion contacting the monomeric or oligomeric healing agent that does not comprise any MOF catalyst and corresponds to the inner shell portion described above. The microcapsule shell will also comprise an outer shell portion formed from said different material, as well as a middle portion between the inner and outer portions. The MOF catalyst will be located in the middle portion, for example dispersed within or on top of a portion of the polymerised healing agent that does not form part of the inner shell portion. In this case, there may be a clear boundary between the outer shell portion and the rest of the microcapsule.

In some embodiments of the invention disclosed herein, the microcapsule shell portion may comprise a ZIF catalyst and the core may comprise a monomeric or oligomeric epoxy resin healing agent.

The self-healing material comprises a polymeric matrix, and the microcapsules may be dispersed within the polymeric matrix. In embodiments of the invention that may be described herein, the self-healing material comprises a polymeric matrix, and the microcapsules may be dispersed approximately evenly throughout the self-healing material, such as throughout substantially all of, or throughout all of, the polymeric matrix. When the metal-organic framework catalyst is present in the polymeric matrix separate to the microcapsules, the metal- organic framework catalyst may be dispersed approximately evenly throughout the self- healing material, such as throughout substantially all of, or throughout all of, the polymeric matrix.

As will be appreciated by a person skilled in the art, there will be a degree of variation in the shape and size of the microcapsules. In embodiments of the invention that may be mentioned herein, the average diameter of the microcapsules may be from about 20 to about 200 μm, for example from about 50 to about 100 μm. Typically, the solid shell portion of the microcapsules in the self-healing material may have an average thickness of from about 100 nm to about 500 nm, for example from about 200 nm to about 400 nm, such as about 300 nm. As used herein, average diameter and average thickness refers to the mean diameter, and the mean thickness, of all of the microcapsules and microcapsule shell portions in a sample.

For the avoidance of doubt, when any numerical range is used herein, the higher and lower values of any related ranges may be combined to provide new ranges, which are all specifically contemplated herein. For example, solid shell portion of the microcapsules in the self-healing material may have an average thickness defined by the following numerical ranges:

from about 100 nm to about 200 nm, from about 100 nm to about 300 nm, from about 100 nm to about 400 nm, from about 100 nm to about 500 nm;

from about 200 nm to about 300 nm, from about 200 nm to about 400 nm, from about 200 to about 500 nm;

from about 300 nm to about 400 nm, from about 300 nm to about 500 nm;

from about 400 nm to about 500 nm.

The invention also provides a method of healing a self-healing material as defined herein, the method comprising a step of subjecting the self-healing material to conditions suitable for polymerisation of the monomeric or oligomeric healing agent.

The healing of a self-healing material disclosed herein may occur over a wide range of temperatures. For example, the polymerisation of the monomeric or oligomeric healing agent may take place at temperatures ranging from room temperature to about 200° C. As will also be appreciated by a person skilled in the art, the healing process will generally be faster when the self-healing material is heated to a higher temperature. Thus, if a lower temperature is used then the healing process is likely to take longer, whereas if a higher temperature is used then the healing process is likely to be shorter. This is evident from the below Examples. While healing at room temperature will be slower than healing at elevated temperature, this is in general not problematic because the self-healing materials heal in situ and healing time is often not a significant concern. Depending on the environment in which the self-healing material is used, nonlimiting examples of temperatures and uses for the self-healing materials include room temperature (uses in general construction), roughly 40° C. to 80° C. (uses in oil pipelines), roughly 100° C. to 180° C. (uses in industrial processes requiring high temperatures). In some embodiments of the invention, the self-healing material is able to self-heal at temperatures of from about 20° C. to about 180° C.

In many cases, the self-healing material will heal at the ambient temperature of the environment in which it is used, whether that is room temperature or a significantly higher temperature such as about 150° C. However, as will be appreciated by a person skilled in the art, where the healing process involves heating the material to an elevated temperature, the self-healing material will be subjected to an elevated temperature for an extended period of time. In such embodiments of the invention that may be mentioned herein, the self-healing material may be heated to an elevated temperature for at least one hour, at last two hours, at least six hours, at least 10 hours, or at least 16 hours, such as about 24 hours.

In a particular embodiment, the self-healing material forms part of an oil or gas pipeline. In this embodiment, the normal operating conditions of the oil or gas pipeline may be sufficient for polymerisation of the healing agent upon contact with the MOF catalyst. In other words, the oil or gas pipeline may operate at a temperature that is sufficient for polymerisation to occur, and the self-healing material will be subjected to this temperature for sufficiently long to ensure that healing takes place.

The invention is illustrated by the below Examples, which are not to be construed as !imitative.

### EXAMPLES

Epikote RIM 935 and Epikure RIMH 936 resin system used in the below Examples were obtained from Hexion (Columbus, Ohio).

### Preparative Example 1: Synthesis of ZIF-8

5.9 g of Zn(NO₃)₂.6H₂O was dissolved in 400 mL of water to form solution A. 113 g of 2-methyl-1H-imidazole were dissolved in 400 mL of water to form solution B. The two solutions were mixed and vigorously stirred for 1 h at room temperature. The resulting ZIF-8 particles were collected by centrifugation for 30 minutes at 10000 rpm and subsequently washed three times with water. The obtained ZIF-8 was dried at room temperature in air or in a vacuum oven.

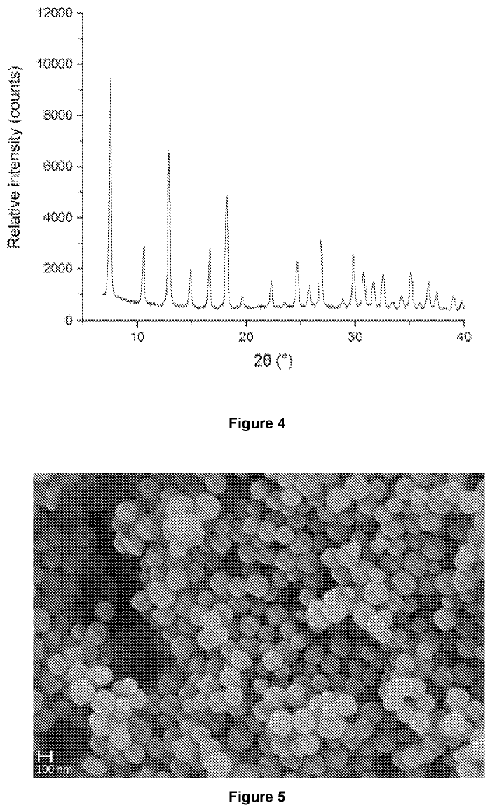

The XRD in FIG. 4 shows characteristic peaks consistent with literature and confirms the successful synthesis of ZIF-8. The SEM image (FIG. 5) shows that the average particle size of ZIF-8 is around 100 nm.

### Preparative Example 2: Synthesis of Melamine-Modified Urea Formaldehyde (MUF)/Epoxy Microcapsules

The microcapsules were prepared via in-situ polymerization from emulsion. The manufacturing process requires three steps: emulsion preparation, prepolymer synthesis, and microencapsulation.

1.35 g gum arabic (GA) and 0.45 g sodium dodecylbenzenesulfonate (SDBS) was dissolved in 60 ml deionized water in a three-neck 250 ml flask, to which bisphenol F diglycidyl ether (DGEBF) epoxy resin (7.2 g) was added under stirring with a propeller mixer at a speed of 500 rpm for 1 h to reach a stable emulsion.

The shell prepolymer was obtained from melamine (0.42 g), urea (2 g) and 37 wt % formaldehyde solution (5.4 g), which were first dissolved under stirring in a 100 ml two-necked flask, then the pH of the solution was raised to 8.5 via dropwise addition of triethanolamine. The temperature was then increased to 70° C. and stirred at reflux for 1 h to obtain a colourless transparent viscous prepolymer, which was then cooled to room temperature.

For the microencapsulation step, the prepolymer was added to the epoxy emulsion dropwise under continuous stirring at 500 rpm. (0.25 g) ammonium chloride (NH₄Cl) was added as pH buffer and catalyst and the pH was set to about 3 by dropwise addition of 10 wt % hydrochloric acid solution, while increasing the temperature to 65° C. The emulsion was stirred for 3 h, then cooled down to room temperature and neutralized with 10 wt % aqueous solution of sodium hydroxide (NaOH). The slurry was washed in deionized water, filtered, and flushed with acetone to remove non-encapsulated epoxy, and dried in air to obtain a white or light yellow free-flowing powder.

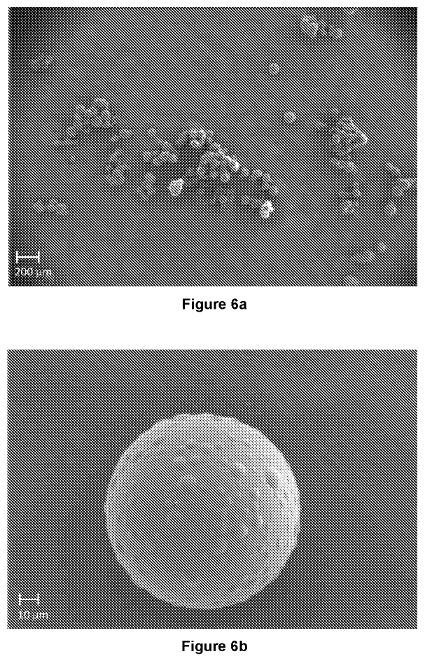

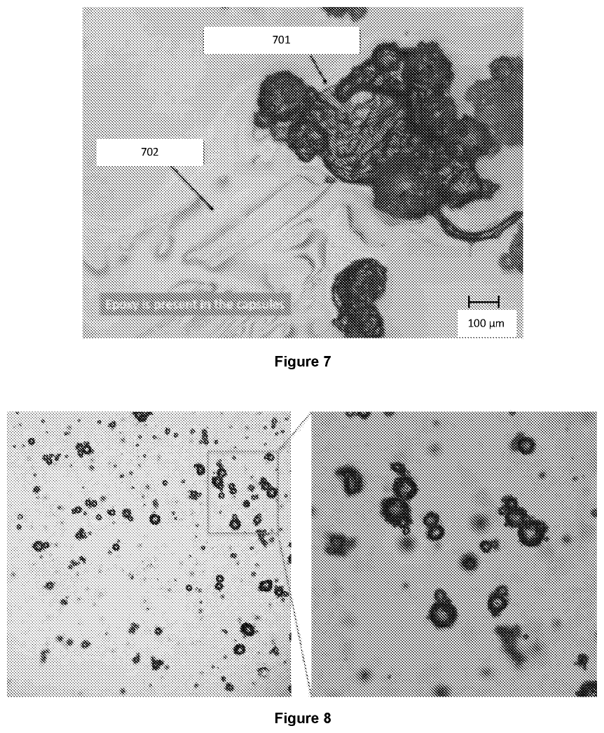

FIG. 6 shows the SEM morphology of the synthesized MUF/epoxy microcapsules with a capsule size between 50 and 100 um. To confirm that epoxy is successfully encapsulated inside the capsule, capsules 701 were manually ruptured and the released epoxy 702 were observed by microscope (FIG. 7) . The capsules could be well dispersed in an epoxy matrix (RIM 935/RIMH936), and were stable and kept intact in epoxy matrix after curing at room temperature for 2 days and post cured at 60° C. for 24 hours (FIG. 8).

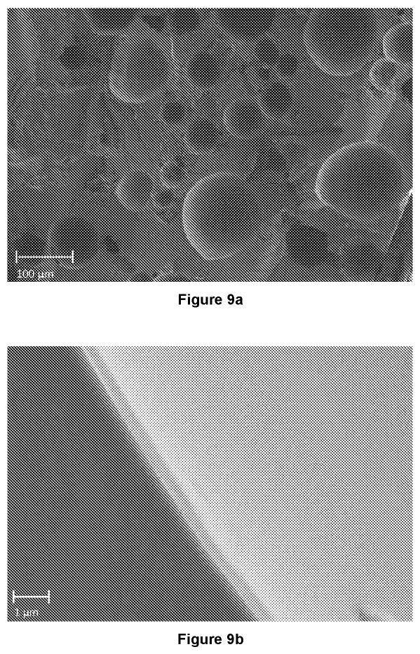

The shell portion thickness was determined by incorporating the capsules in RIM 935/RIMH936 bars and observing the cross section. The shell portion thickness is about 300 nm, and good dispersion in the matrix is observed as shown in FIG. 9. The capsules at the fracture surface appear to broken, which is positive for the release of epoxy.

### Preparative Example 3: Preparing the Self-Healing Material

The self-healing agent, MUF/epoxy microcapsules and MOF catalyst, ZIF-8, were incorporated in RIM 935/RIMH936 (RIM 935) epoxy matrix to test self-healing. The sample compositions and curing profiles are listed in Table 1.

TABLE 1
Composition and curing cycles for the samples
used for the self-healing study.

| | | MUF/ | | |
|---|---|---|---|---|
| | RIM935/ | epoxy | | |
| | RIM H936 | capsule | ZIF8 | Curing |
| Sample | (wt %) | (wt %) | (wt %) | procedure |
| Bare RIM935 (a) | 100 | — | — | 2 days at room |
| | | | | temperature, |
| | | | | 24 h at 60° C. |
| 8% ZIF8 in RIM935 (b) | 92 | — | 8 | As above |
| 25% capsule-8% ZIF8 in | 67 | 25 | 8 | As above |
| RIM935 (c) | | | | |
| 15% capsule-5% ZIF8 in | 80 | 15 | 5 | As above |
| RIM935 (d) | | | | |

### Example 1: In-Situ Scratch Healing Process

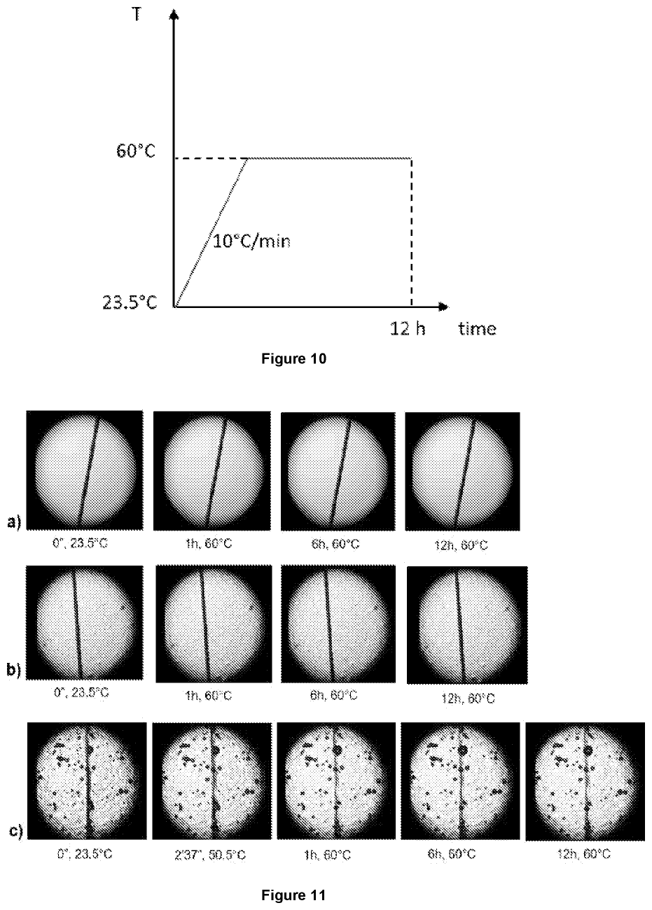

The control samples of bare RIM 935 (a) and 8% ZIF8 in RIM 935 (b), and the self-healing sample of 25% MUF capsule-8% ZIF8 in RIM 935 (c) from Preparative Example 3 were cast onto glass slides. After curing, the samples were scratched and healed in-situ on a temperature controlled stage under optical microscope with transmittance mode. The temperature profile is shown in FIG. 10: the samples was elevated from 23.5° C. to 60° C. at a heating rate of 10° C., and then hold for 12 hours. FIG. 11 shows the images taken from the in-situ healing video. It can be seen that the control samples of bare RIM 935 (a) and 8% ZIF8 in RIM 935 (b) were unchanged during the healing process. In contrast, the self-healing sample comprising 25% capsule-8% ZIF8 in RIM 935 (c) shows healing along the scratch.

### Example 2: Scratch Microscope Test

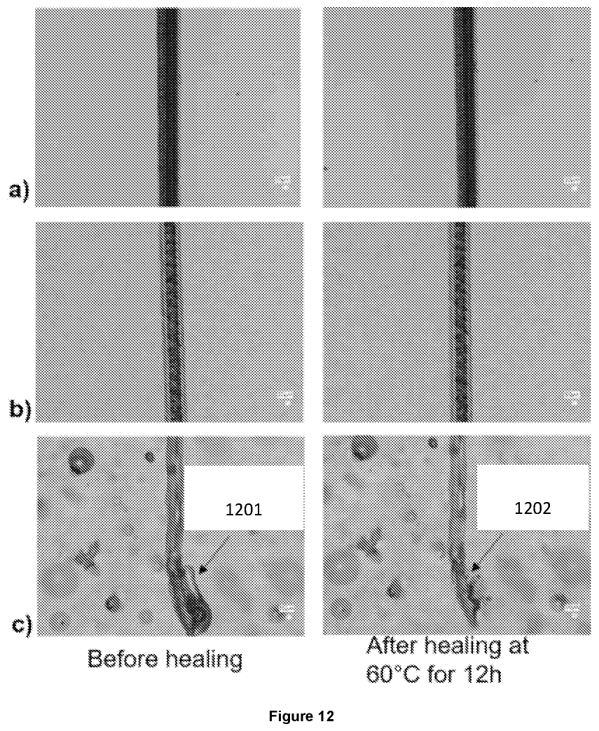

The control samples of bare RIM 935 (a) and 8% ZIF8 in RIM 935 (b), and the self-healing sample of 25% MUF capsule-8% ZIF8 in RIM 935 (c) from Preparative Example 3 were cast on carbon steel plate and scratched with a sharp razor blade. FIG. 12 shows microscope images of samples before and after 12 h healings at 60° C. There is no change before and after healing for bare RIM 935 (a) and 8% ZIF8 in RIM 935 (b). For the 25% MUF capsule-8% ZIF8 in RIM 935 sample (c), epoxy resin 1201 can be seen to have been released from the ruptured microcapsules before healing. After healing, it can be seen that the released epoxy 1202 was cured.

### Example 3: Electrochemical Impedance Spectroscopy (EIS)

The self-healing ability of the polymeric matrix with the encapsulated epoxy as the healing agent and ZIF-8 as the catalyst was assessed by Electrochemical Impedance Spectroscopy (EIS). The carbon steel plates were coated with samples (a) to (d) from Preparative Example 3, as described in Example 2 above. The coated carbon steel plates were scratched (about 5 mm length) to the substrate with a razor blade. The samples were then healed at 60° C. for 12 h, and then tested in the EIS setup. 0.5M NaCl solution was used as electrolyte. The test is conducted at open circuit potential at 20 mV voltage amplitude with a range of 0.05-10000Hz. The frequency response at 0.1Hz is considered for evaluation of the coating performance.

In order to quantify the healing performance, a healing efficiency parameter is defined as

$$Healing efficiency = \frac{log \vert Z \vert - log {\vert Z \vert}_{scratched coating}}{log {\vert Z \vert}_{pristine coating} - log {\vert Z \vert}_{s cratched coating}}$$

Where |Z| is the impedance for the scratched and healed coating, |Z|_{scratched coating} is the impedance for the scratched non-healing coating and |Z|_{pristine coating} is the impedance of pristine coating. The logarithm is used since the improvement in barrier properties do not improve linearly with the impedance modulus, but rather with its logarithm.

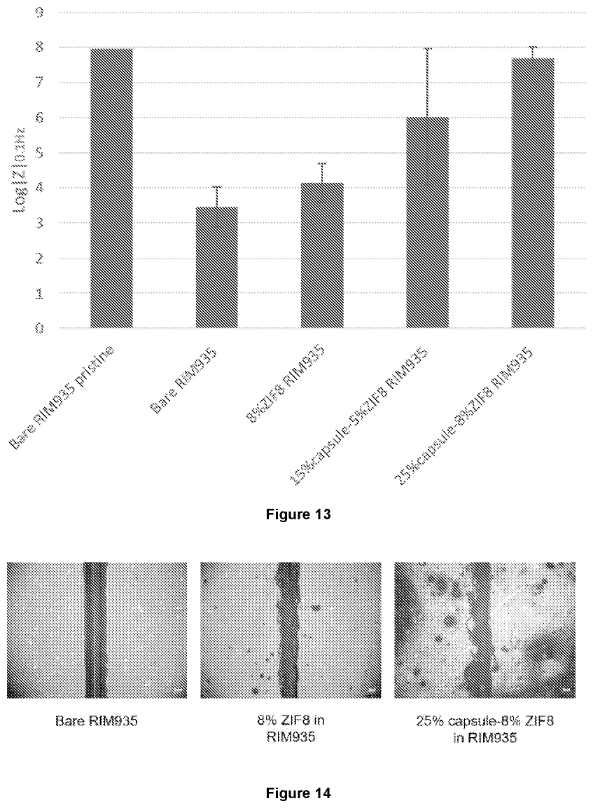

FIG. 13 and Table 2 show the healing performance of the control samples as well as the self-healing samples with 15% capsule-5% ZIF8 in RIM 935 and 25% capsule-8% ZIF8 in RIM 935. For reference, the samples in pristine conditions show a log|Z|_{0.1 Hz} of about 8. The log|Z|_{0.1 Hz} of the unhealed scratch sample is about 4. From FIG. 13 and Table 2, it can be seen that the bare RIM 935 sample (a) and 8% ZIF8 in RIM 935 (b) did not heal at all. The samples with 15% capsule-5% ZIF8 in RIM 935 (d) and 25% capsule-8% ZIF8 (c) had healing efficiencies of 50% and 92%, respectively. After the 20 h EIS test of exposure to salt water, the self-healing samples comprising microcapsules and ZIF8 did not show signs of corrosion, whereas the non-self-healing control samples did show signs of corrosion. These results confirm the EIS findings.

TABLE 2
log|Z|_{0.1 Hz} and healing efficiency
for control and self-healing samples.

| | | EIS Healing |
|---|---|---|
| | Log | efficiency |
| Sample | (\|Z\|/Ohm) | [%] |
| RIM935 pristine (a) | 7.96 | — |
| RIM935 after scratch and healing (a) | 3.47 ± 0.57 | 0 |
| 8% ZIF8 RIM935 after scratch and | 4.14 ± 0.55 | 0 |
| healing (b) | | |
| 25% capsule-8% ZIF8 RIM935 after | 7.70 ± 0.31 | 92 |
| scratch and healing (c) | | |
| 15% capsule-5% ZIF8 RIM935 after | 6.01 ± 1.94 | 50 |
| scratch and healing (d) | | |

Optical microscopy images of the samples are shown in FIG. 14.

### Example 4: Single Edge Notched Bend Test (SENB)

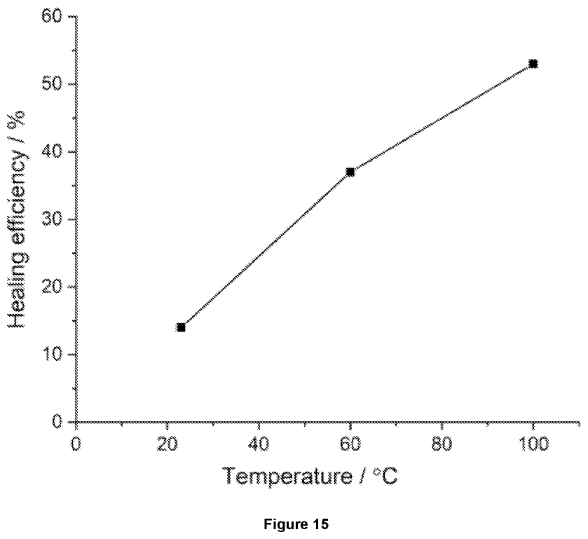

SENB standard test (ASTM5045) was performed and provides further evidences of the healing ability of the samples, with quantifiable recovery of mechanical properties. The results are shown in Table 3 and FIG. 15. The RIM 935 control sample (a) was not healed at both room temperature and 60° C. The sample with 25% capsule-8% ZIF8 in RIM 935 (c) has a mechanical healing efficiency of 14%, 37% and 53% at room temperature, 60° C. and 100° C., respectively, indicating that the higher the temperature, the higher healing efficiency.

TABLE 3
SENB healing efficiency for control and self-healing samples.

| | | SENB Healing |
|---|---|---|
| | Max load | Efficiency |
| Sample | [N] | [%] |
| RIM935 pristine (a) | 72.61 ± 17.37 | — |
| RIM935 healed RT 2 days (a) | 1.71 ± 1.97 | 2 |
| RIM935 healed 60° C. 12 h (a) | 1.83 ± 1.59 | 3 |
| 25% MUF 8% ZIF8 RIM935 | 52.94 ± 10.06 | — |
| pristine (c) | | |
| 25% MUF 8% ZIF8 RIM935 | 7.37 ± 4.50 | 14 |
| healed RT 2 days (c) | | |
| 25% MUF 8% ZIF8 RIM935 | 19.52 ± 1.25 | 37 |
| healed 60° C. 12 h (c) | | |
| 25% MUF 8% ZIF8 RIM935 | 28.25 ± 3.51 | 53 |
| healed 100_C. 4 h | | |

### Example 5: Preparation of Microcapsules having Catalyst Embedded in the Shell

An oil in water Pickering emulsion was prepared from an aqueous phase comprising distilled water and ZIF-8, and an oil phase comprising epoxy resin, styrene, divinylbenzene, azobisisobutyronitrile and dichloromethane. The water and oil phases were mixed together via vigorous shear mix to obtain a Pickering emulsion stabilized by ZIF 8 nanoparticles locating at the oil-water interface. N₂ gas was bubbled through the emulsion to remove air. The reaction mixture was then heated to 65° C. and was polymerized at that temperature for 16 hours under nitrogen and reflux. The final product was isolated via centrifuge and repeated wash, and subsequently dried in air.

1. A self-healing material comprising:
a polymeric matrix;
microcapsules comprising a shell portion and a hollow core portion, where the microcapsules are dispersed within the polymeric matrix and the hollow core portion is filled with a monomeric or oligomeric healing agent; and
a metal-organic framework catalyst that is suitable for catalysing the polymerisation of the monomeric or oligomeric healing agent.

2. The self-healing material according to claim 1, wherein the metal- organic framework catalyst is dispersed within the polymeric matrix.

3. The self-healing material according to claim 1, wherein the shell portion of the microcapsules is formed from one or more of the group consisting of a urea-formaldehyde, polysulfone, and polymethyl methacrylate.

4. The self-healing material according to claim 3, wherein the shell portion of the microcapsules is formed from a urea-formaldehyde.

5. The self-healing material according to claim 1, wherein the average diameter of the microcapsules is from about 20 μm to about 200 μm.

6. The self-healing material according to claim 1, wherein the shell portion of the microcapsules has an average thickness of from about 100 nm to about 500 nm.

7. The self-healing material according to claim 1, wherein the self-healing material comprises from about 10 to about 30 wt % of the microcapsules.

8. The self-healing material according to claim 1, wherein the self-healing material comprises from about 1 to about 10 wt % of metal-organic framework catalyst.

9. The self-healing material according to claim 1, wherein the shell portion of the microcapsules comprises an inner portion and an outer portion, where the outer portion comprises the metal-organic framework catalyst.

10. The self-healing material according to claim 9, wherein the inner portion is formed from polymerised monomeric or oligomeric healing agent.

11. The self-healing material according to claim 9, wherein the outer portion is formed from polymerised monomeric or oligomeric healing agent, or wherein the outer portion is formed from one or more of the group consisting of a urea-formaldehyde, polysulfone, and polymethyl methacrylate.

12. The self-healing material according to claim 11, wherein the outer portion is formed from polymerised monomeric or oligomeric healing agent.

13. The self-healing material according to claim 11, wherein the outer portion is formed from a urea-formaldehyde.

14.-17. (canceled)

18. The self-healing material according to claim 1, wherein the monomeric or oligomeric healing agent comprises an epoxy resin.

19. The self-healing material according to claim 1, wherein the epoxy resin comprises an epoxy resin selected from the group consisting of bisphenol epoxy resins; glycidyl ether resins; glycidyl aniline resins; and novolac, aliphatic, cycloaliphatic, aromatic, and bio-based epoxy resins that have from 1 to 6 epoxy groups.

20. The self-healing material according to claim 1, wherein the metal-organic framework comprises a zeolitic imidazolate framework.

21. The self-healing material according to claim 1, wherein the metal-organic framework comprises ligands selected from the group consisting of imidazole, 2-methylimidazole, 2-nitroimidazole, 4,5-dichloroimidazole, 2-imidazolecarboxaldehyde and combinations thereof.

22. The self-healing material according to claim 1, wherein the metal-organic framework comprises a zeolitic imidazolate framework selected from the group consisting of ZIF-2, ZIF-3, ZIF-4, ZIF-8, ZIF-67, ZIF-65, ZIF-77, ZIF-71, ZIF-72, ZIF-90 and combinations thereof.

23. The self-healing material according to claim 1, wherein the metal-organic framework comprises ZIF-8.

24. A method of healing a self-healing material as defined in claim 1, comprising a step of subjecting the self-healing material to conditions suitable for polymerisation of the monomeric or oligomeric healing agent.

25.-27. (canceled)
